(19) United States
(12) Patent Application Publication
(10) Pub. No.: US 2015/0369231 A1
(43) Pub. Date: Dec. 24, 2015

(54) MAGNETOCALORIC DRIVING DEVICES

(71) Applicant: GENERAL ELECTRIC COMPANY, Schenectady, NY (US)

(72) Inventors: Matthew Alexander Lehar, Munich (DE); Michael Alexander Benedict, Louisville, KY (US); Juan Albeniz Goicoechea, Munich (DE)

(21) Appl. No.: 14/566,856

(22) Filed: Dec. 11, 2014

Related U.S. Application Data
(60) Provisional application No. 62/015,699, filed on Jun. 23, 2014.

(51) Int. Cl. F04B 19/24; F03G 7/06

(52) U.S. Cl. CPC F04B 19/24; F03G 7/06

(57) ABSTRACT

A magnetocaloric driving device is disclosed herein. The driving device comprises a magnet, an effective amount of a magnetocaloric material, and a counterpoise mechanism. The driving device generates useful mechanical energy by alternately cooling and heating the magnetocaloric material using an ambient heat sink proximate to a heat source. Useful heat sources include hot production fluids, such as hot water produced from a geothermal well. Useful heat sinks include cold production fluids, and cold ambient environments.

### CROSS REFERENCE TO RELATED APPLICATIONS

This application claims the benefit of U.S. Provisional Application No. 62/015,699, entitled “MAGNETOCALORIC VALVE”, filed Jun. 23, 2014, and which is incorporated herein by reference in its entirety.

### BACKGROUND

The present invention relates to magnetocaloric devices which use heat sinks proximate to heat sources to create useful mechanical energy. In particular, the invention relates to devices which are largely energetically self-sufficient.

Many human activities involve the deployment of devices requiring a power source in environments far removed from customary sources of power such as an electricity grid. As such, the development of energetically self-sufficient devices powered by sunlight or the motion of fluids has gained additional currency in recent years, and builds upon a rich tradition of human experience in energetically self-sufficient technologies such as windmills and waterwheels. The accomplishments of the recent past notwithstanding, further enhancements are needed.

The discovery of magnetocaloric effect nearly a century and a half ago by German physicist Emil Warburg, and the sustained interest in materials exhibiting his effect in the intervening years has produced an immense body of knowledge related to magnetocaloric materials and their use as heat sinks in reliance upon the principle of magnetization-demagnetization. The present invention leverages the magnetocaloric effect to produce devices which are largely energetically self-sufficient.

### BRIEF DESCRIPTION

In one embodiment, the present invention provides a magnetocaloric driving device comprising: a magnet, an effective amount of a magnetocaloric material, and a counterpoise mechanism; wherein the driving device is configured to generate mechanical energy by alternately cooling and heating the magnetocaloric material using a heat sink proximate to a heat source.

In another embodiment, the present invention provides a magnetocaloric driving device comprising: a magnet, an effective amount of a magnetocaloric material, and a counterpoise mechanism; wherein the driving device is configured to generate mechanical energy by alternately cooling the magnetocaloric material by thermal contact with an ambient heat sink and heating the magnetocaloric material by thermal contact with a production fluid.

In an alternate embodiment, the present invention provides a magnetocaloric pump comprising: a magnetocaloric driving device comprising a magnet, an effective amount of a magnetocaloric material, and a counterpoise mechanism; and a vessel defining a first compartment and a second compartment, separated by a blocking member configured to translate in a first direction under the influence of an attractive force between the magnetocaloric material and the magnet, and to translate in a second direction under the influence of a stored counter-force; wherein the first compartment is configured to receive and transmit a first fluid having an average temperature T₁, the second compartment is configured to receive and transmit a second fluid having an average temperature T₂, the blocking member being configured to limit fluid communication between the first and second compartments, the pump being configured such that T₁ is substantially greater than T₂.

### BRIEF DESCRIPTION OF THE DRAWING FIGURES

Various features, aspects, and advantages of the present invention will become better understood when the following detailed description is read with reference to the accompanying drawings in which like characters may represent like parts throughout the drawings. Unless otherwise indicated, the drawings provided herein are meant to illustrate key inventive features of the invention. These key inventive features are believed to be applicable in a wide variety of systems comprising one or more embodiments of the invention. As such, the drawings are not meant to include all conventional features known by those of ordinary skill in the art to be required for the practice of the invention.

FIG. 1 illustrates a magnetocaloric driving device and pump provided by the present invention;

FIG. 2 illustrates a magnetocaloric driving device and pump provided by the present invention;

FIG. 3 illustrates components of a magnetocaloric driving device and pump provided by the present invention;

FIG. 4 illustrates a magnetocaloric driving device and pump provided by the present invention;

FIG. 5 illustrates a components of a magnetocaloric driving device and pump provided by the present invention;

FIG. 6 illustrates a magnetocaloric driving device and pump provided by the present invention;

FIG. 7 illustrates a magnetocaloric driving device and pump provided by the present invention;

FIG. 8 illustrates a magnetocaloric driving device provided by the present invention;

FIG. 9 illustrates a magnetocaloric driving device provided by the present invention;

FIG. 10 illustrates components of a magnetocaloric driving device provided by the present invention;

FIG. 11 illustrates a magnetocaloric driving device and pump provided by the present invention;

FIG. 12 illustrates a magnetocaloric driving device and pump provided by the present invention;

FIG. 13 illustrates a magnetocaloric driving device and pump provided by the present invention; and

### DETAILED DESCRIPTION

In the following specification and the claims, which follow, reference will be made to a number of terms, which shall be defined to have the following meanings.

The singular forms “a”, “an”, and “the” include plural referents unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As noted, in one or more embodiments, the present invention provides a magnetocaloric driving device comprising: a magnet, an effective amount of a magnetocaloric material, and a counterpoise mechanism; wherein the driving device is configured to generate mechanical energy by alternately cooling and heating the magnetocaloric material using a heat sink proximate to a heat source. As such, the devices provided by the present invention can be used in almost any application requiring mechanical energy, such as valves, motors, locking mechanisms, generators and the like. This disclosure illustrates the magnetocaloric driving devices provided by the present invention deployed within pumps which are largely energetically self-sufficient.

As noted, in one or more embodiments the present invention provides a magnetocaloric driving device and methods for its operation which rely on heat exchange between a magnetocaloric component of the driving device and an ambient heat sink and a production fluid heat source, to generate the force required to provide useful mechanical energy. In alternate embodiments, an ambient heat source and a production fluid heat sink are used to generate the force required to provide useful mechanical energy.

In one or more embodiments, the present invention provides a magnetocaloric pump powered by a magnetocaloric driving device. As is detailed herein, the magnetocaloric driving device may operate in a variety of states to cause a fluid to flow or to prevent its flowing. In one or more embodiments, the magnetocaloric material of the magnetocaloric driving device used to power the pump is alternately cooled by thermal contact with an ambient heat sink and warmed by thermal contact with a production fluid heat source.

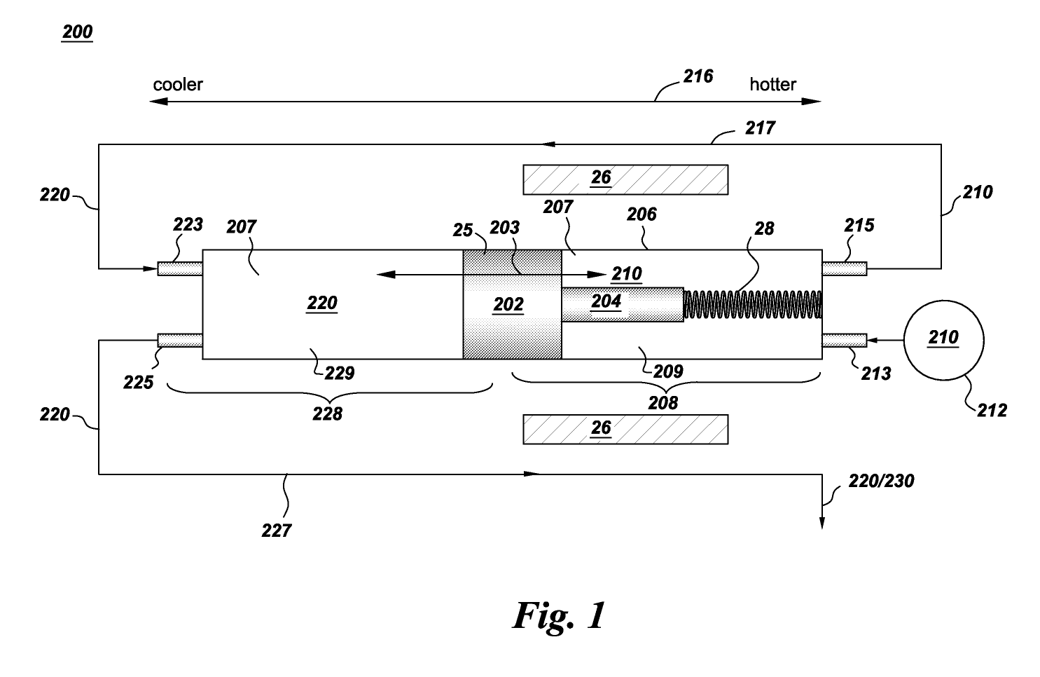

The discussion which follows illustrates the physical and operational principles underlying the present invention using the embodiment shown in FIG. 1 as a specific example of both a magnetocaloric pump and a magnetocaloric driving device. The figure illustrates their operation, and should not be construed as limiting, since various other embodiments are also disclosed herein.

FIG. 1 illustrates an embodiment of the present invention in which a magnetocaloric driving device is used to drive a fluid pump 200. Fluid pumps driven by magnetocaloric driving devices are at times herein referred to as magnetocaloric pumps. The magnetocaloric pump 200 comprises a cylindrical vessel 206 defining a first compartment 209 and a second compartment 229, the two compartments being separated by magnetocaloric piston 202 which serves both as a blocking member limiting direct fluid communication between the compartments and as a component of the magnetocaloric driving device used to drive the pump. The first compartment 209 is configured to receive and transmit a first fluid 210 having an average temperature T₁, and the second compartment 229 is configured to receive and transmit a second fluid 220 having an average temperature T₂. In the embodiment shown the pump is configured such that T₁ is substantially greater than T₂. For the purposes of this disclosure, T₁ is substantially greater than T₂ when T₁ is more than five (5) degrees centigrade greater than T₂. In one or more embodiments, T₁ is more than fifty (50) degrees centigrade greater than T₂. In another set of embodiments, T₁ is more than one hundred (100) degrees centigrade greater than T₂. In yet another set of embodiments, T₁ is more than one hundred and fifty (150) degrees centigrade greater than T₂.

In the embodiment shown, a reciprocating movement 203 of the magnetocaloric piston 202 is used to cause a fluid to flow. A first piston stroke is initiated when the piston moves in response to an attractive interaction between fixed magnet 26 and a magnetocaloric material 25 in a magnetically susceptible state contained in the piston. Magnetically susceptible with respect to the magnetocaloric material means that the magnetocaloric material is attracted to the magnet. This means that the temperature of the magnetocaloric material (T_{MCM}) is below its magnetic transition temperature (T_{C}). As the magnetocaloric piston and its associated piston shaft 204 move in response to the attractive interaction between the magnet and the magnetocaloric material, energy is stored in a counterpoise mechanism 28 coupled to the piston shaft 204. In one or more embodiments, the counterpoise mechanism is a return spring, at times herein referred to as a compressible spring, which stores energy as it is compressed.

The counterpoise mechanism tends to counteract the motion induced by the attractive interaction between the magnetocaloric material and the magnet. The magnetocaloric component of the piston, the magnet and the counterpoise mechanism are sized appropriately such that a force sufficient to overcome the resistance of the counterpoise mechanism is provided by the attractive interaction of the magnet with the magnetocaloric material and create thereby a mechanical counter-force in the counterpoise mechanism. As will be appreciated by those of ordinary skill in the art, the magnetocaloric material is attracted to the magnet when cold (T_{MCM} below T_{C}), and is not attracted to the magnet when warm (T_{MCM} above T_{C}).

In various embodiments, the magnetocaloric material is alternately exposed to a cold zone of the pump 228 and a hot zone 208 of the pump, the hot and cold zones creating a temperature gradient 216 through which the magnetocaloric piston moves. In the cold zone the average temperature of fluid 220 is lower than the magnetic transition temperature (T_{C}) of the magnetocaloric material 25, the cold zone of the pump being in thermal contact with a cold ambient environment. As the piston moves toward the magnet, hot fluid 210 is forced from the hot zone of pump cavity 207 via fluid outlet 215 while drawing cold fluid 220 into the cold zone of cavity 207 via fluid inlet 223.

As the magnetocaloric material warms and the strength of the attractive interaction between the magnet and the magnetocaloric material weakens, the mechanical counter-force stored in counterpoise mechanism 28 drives the magnetocaloric piston back into the cold zone of the device where the magnetocaloric material loses heat and becomes magnetically susceptible once again.

As the magnetocaloric piston is displaced by the counterpoise mechanism away from magnet 26, cold fluid 220 is forced from the cold zone 228 of pump cavity 207 via fluid outlet 225 while drawing hot fluid 210 into the hot zone of pump cavity 207 via fluid inlet 213. Those of ordinary skill in the art will appreciate that fluid inlets 213 and 223, and fluid outlets 215 and 225, may be appropriately equipped with check valves in order to control the fluid input into and fluid output from the pump.

In the embodiment shown in FIG. 1, hot fluid 210 is shown as coming from hot fluid source 212. Hot fluid 210 may be any hot fluid compatible with the pump and may be a hot production fluid, or a hot secondary fluid produced by thermal contact of a hot production fluid with a cold secondary fluid. In one embodiment, hot fluid 210 is a gaseous hydrocarbon produced from a dry gas well and element 212 is a well head. In an alternate embodiment, hot fluid 210 is a liquid hydrocarbon separated from a production fluid and element 212 is a heat exchanger. In yet another embodiment, hot fluid 210 is hot water being extracted from a geothermal aquifer.

In the embodiment shown in FIG. 1, as magnetocaloric piston 202 moves toward magnet 26 hot fluid 210 is forced from the hot zone 208 of the pump via fluid outlet 215 and passes into conduit 217 connecting the hot and cold zones. In the embodiment shown, fluid conduit 217 is in thermal contact with a cold ambient environment and heat is lost to the cold ambient as hot fluid 210 passes through conduit 217. Thus upon arrival at fluid inlet 223 of the cold zone hot fluid 210 has been transformed into cold fluid 220.

For the purpose of this disclosure, a hot fluid is characterized by one or more temperatures T₁ and a cold fluid is characterized by one or more temperatures T₂, and T₁ is greater than T₂.

Cold fluid 220 is forced from cold zone 220 via fluid outlet 225 as magnetocaloric piston 202 moves away from magnet 26 and passes through fluid conduit 227 to a pump outlet. In the embodiment shown, the fluid output of the pump 230 is cold fluid 220.

In one or more embodiments, a magnetocaloric driving device provided by the present invention is configured for use in hydrocarbon production operations on the sea floor where the ambient environment consists of deep ocean water which is characterized by its high salinity, 3 to 4 percent by weight, and its cold temperature, 0 to 3 degrees centigrade. Under such circumstances, the ambient environment surrounding the magnetocaloric driving device may act as a suitable heat sink to which heat may be transferred from the magnetocaloric component of the device. The production fluid being produced by the hydrocarbon production operation is typically a hot, multiphase fluid made up of liquid and gaseous hydrocarbons, water and other components such hydrogen sulfide and carbon dioxide. While the temperature of the production fluid used as a heat source for a magnetocaloric driving device on the ocean floor will be cooler than the bottomhole temperature of the producing well, it will typically be considerably hotter than the ambient temperature at the sea floor and the magnetic transition temperature, T_{C}, of the magnetocaloric material. As such, a variety of production fluid types may serve as a suitable heat source. The heat sink and its complementary heat source together with the magnet, magnetocaloric material and counterpoise mechanism may be used to provide the power needed to operate equipment. Remarkably, the magnetocaloric driving device illustrated in FIG. 1 is energetically self-sufficient with respect to its two major operating functions: storing mechanical energy in and releasing mechanical energy from the counterpoise mechanism. This self-sufficiency confers a major advantage on the magnetocaloric driving devices provided by the present invention over customarily used devices requiring an external source of mechanical or electric power.

In one or more embodiments, the magnetocaloric driving device may be driven using the ambient surface environment as a heat sink and a production fluid as a heat source, as in surface oil production operations in cold environments such as the arctic, in which a hot production fluid is being produced.

Alternatively, the magnetocaloric driving device may be driven using a hot ambient environment as a heat source and a cold production fluid as a heat sink, as may be the case in water producing wells in which a stream of cold, potable water is being produced from an aquifer situated in a hot environment such as a meridional desert.

The magnetocaloric material employed is such that its magnetic transition temperature is greater than the temperature of the heat sink employed, and such that, when cold, it is attracted to the driving device magnet. A wide variety of magnetocaloric materials are currently available, and the discovery of new magnetocaloric materials continues at a rapid pace. Suitable magnetocaloric materials include gadolinium metal; LaFe₁₃₋ₓSiₓ alloys wherein x varies from about 1 to about 2.7, for example LaFe_{11.83}Si_{1.17}, LaFe_{11.7}Si_{1.13}, LaFe_{11.5}Si_{1.15}, and LaFe_{11.2}Si_{1.8}; La_{1-y}Pr_{y}Fe₁₃₋ₓSiₓ alloys wherein y varies from about 0.1 to about 0.5 and x varies from about 1 to about 2, for example La_{0.9}Pr_{0.1}Fe_{12.0}Si_{1.0}, La_{0.8}Pr_{0.2}Fe_{11.8}Si_{1.2}, La_{0.7}Pr_{0.3}Fe_{11.7}Si_{1.3}, La_{0.9}Pr_{0.1}Fe_{11.5}Si_{1.5}, La_{0.8}Pr_{0.2}Fe_{11.5}Si_{1.5}, and La_{0.5}Pr_{0.5}Fe_{11.5}Si_{1.5}; LaFe₁₃₋ₓSiₓH_{β} alloys where x varies from about 1 to about 2.7 and β varies from about 0.1 to about 2, for example LaFe_{12.0}Si_{2.0}H_{0.1}, LaFe_{11.5}Si_{1.5}H_{0.2}, LaFe_{11.7}Si_{1.3}H_{0.3}, LaFe_{11.5}Si_{1.5}H_{0.3}, LaFe_{11.5}Si_{1.5}H_{0.6}, LaFe_{11.5}Si_{1.5}H_{1.3}, LaFe_{11.5}Si_{1.5}H_{1.5}, and LaFe_{11.5}Si_{1.5}H_{1.8}; La(Fe_{1-y}Mn_{y})₁₃₋ₓSiₓH_{α} alloys where y varies from about 0.01 to about 1, x varies from about 1 to about 2.5, and α indicates the presence of absorbed hydrogen within the lattice of the magnetocaloric material, for example La(Fe_{0•99}Mn_{0.01})_{11.7}Si_{1.3}H_{α}, La(Fe_{0•98}Mn_{0.02})_{11.7}Si_{1.3}H_{α}, La(Fe_{0•97}Mn_{0.03})_{11.7}Si_{1.3}H_{α}, La(Fe_{0•99}Mn_{0.01})_{11.8}Si_{1.2}H_{α}, La(Fe_{0•99}Mn_{0.01})_{11.9}Si_{1.1}H_{α}, La(Fe_{0•99}Mn_{0.01})_{11.4}Si_{1.6}H_{α}, La(Fe_{0•99}Mn_{0.01})_{11.3}Si_{1.7}H_{α}, La(Fe_{0•99}Mn_{0.01})_{11.3}Si_{1.7}H_{α}, La(Fe_{0•99}Mn_{0.01})_{11.1}Si_{1.9}H_{α}, La(Fe_{0•99}Mn_{0.01})_{11.0}Si_{2.0}H_{α}, and La(Fe_{0•99}Mn_{0.01})_{10.8}Si_{2.2}H_{α}; La(Fe_{1-y}Co_{y})₁₃₋ₓSiₓ alloys where y varies from about 0.01 to about 1 and x varies from about 1 to about 2.5, for example La(Fe_{0.96}Co_{0.04})_{11.9}Si_{1.1}, La(Fe_{0.94}Co_{0.06})_{11.9}Si_{1.1}, La(Fe_{0.92}Co_{0.08})_{11.9}Si_{1.1}, La(Fe_{0.91}Co_{0.09})_{11.9}Si_{1.1}, La(Fe_{0.92}Co_{0.08})_{11.8}Si_{1.2}, La(Fe_{0.92}Co_{0.08})_{11.7}Si_{1.3}, La(Fe_{0.92}Co_{0.08})_{11.6}Si_{1.4}, La(Fe_{0.92}Co_{0.08})_{11.5}Si_{1.5}, La(Fe_{0.92}Co_{0.08})_{11.4}Si_{1.6}, La(Fe_{0.92}Co_{0.08})_{11.2}Si_{1.8}, La(Fe_{0.92}Co_{0.08})_{11.1}Si_{1.9}, and La(Fe_{0.92}Co_{0.08})_{11.0}Si_{2.0}; and LaFe₁₃₋ₓ(Co_{y}Si_{z})ₓ alloys where x varies from about 1 to about 2.5, y varies from about 0.1 to about 1.5, z varies from about 1 to about 2 and y+z=x, for example LaFe_{11.2}Co_{0.7}Si_{1.1}, LaFe_{10.7}Co_{0.8}Si_{1.5}, LaFe_{10.98}Co_{0.22}Si_{1.8}, LaFe_{10.8}Co_{0.8}Si_{1.4}, LaFe_{10.9}Co_{0.8}Si_{1.3}, and LaFe_{11.0}Co_{0.8}Si_{1.2}. Other suitable magnetocaloric materials include CrO₂₋ₓFₓ alloys where x varies from about 0.01 to about 0.25, for example CrO_{1.88}F_{0.12}, CrO_{1.89}F_{0.11}, CrO_{1.90}F_{0.10}, CrO_{1.87}F_{0.13}, CrO_{1.86}F_{0.14}, CrO_{1.85}F_{0.15}, CrO_{1.84}F_{0.16}, CrO_{1.83}F_{0.17}, and CrO_{1.82}F_{0.18}.

In one or more embodiments, the magnetocaloric material present in the magnetocaloric component of the driving device provided by the present invention is integral to such component. For example, a magnetocaloric piston may consist entirely or partially of the magnetocaloric material. In an alternate set embodiments, the magnetocaloric component of the driving device comprises a reservoir configured to accommodate an effective amount of the magnetocaloric material, for example a magnetocaloric piston may comprise a housing defining an interior volume containing the magnetocaloric material. In one or more embodiments, the magnetocaloric component of the magnetocaloric driving device is a shaft-mounted reservoir containing a magnetocaloric material 25. The reservoir may be hermetically sealed to prevent contact between a working fluid of the device and the interior of the reservoir. The reservoir may optimally comprise a heat transmissive housing and internal heat transmissive fins to enhance the rate at which heat may be exchanged between the magnetocaloric material and a hot fluid or a cold fluid as the case may be.

The magnet employed is typically a permanent magnet but may in certain embodiments be an electromagnet. Suitable permanent magnets are well known in the art and include ceramic magnets, composites comprising iron oxide and barium carbonate and/or strontium carbonate; samarium cobalt magnets, and neodymium-iron-boron magnets. As noted, the magnet and the magnetocaloric component of the valve are sized and positioned such that when the magnetocaloric material is in a cold state the magnet and magnetocaloric material are attracted to one another. In various embodiments, the cold magnetocaloric component is displaced toward the fixed magnet. In various other embodiments, the magnet is displaced toward a cold, fixed magnetocaloric component. In yet other embodiments, both the magnet and cold magnetocaloric component are displaced as a result of the mutual attraction of the cold magnetocaloric material and the magnet.

The strength of the interaction between the magnet and the cold magnetocaloric material will depend on the sizes of the magnet and the magnetocaloric component, their compositions, and their propinquity within the magnetocaloric driving device. The strength of the interaction between the magnet and the magnetocaloric material will also determine the force with which the magnetocaloric component can be made to move. In various embodiments, the magnet and the amount and nature of the magnetocaloric material may be chosen to coincide with the required force and distance of displacement. In one embodiment, a mass m_{MCM} of a magnetocaloric material having a magnetic moment M_{MCM} and mechanically joined to a movable valve shaft is attracted to a permanent magnet having a field strength H_{PM}. At a given temperature the product M_{MCM}×m_{MCM}×H_{PM} represents the torque developed by the magnetocaloric material and the permanent magnet. Table 1 below further illustrates this concept for a hypothetical magnetocaloric material having a magnetic moment of 100 Joule per Tesla per kilogram. For reference, one Joule is the energy exerted by a force of one Newton acting to move an object through a distance of one meter, and is about the amount of energy required to move a tennis ball upwardly through a distance of one meter. For a substantial amount of magnetocaloric material (See Entry 1) being acted on by a strong magnetic field, a substantial level of torque may be developed and used to perform useful work in a large magnetocaloric driving device, such as that used to power a large magnetocaloric valve. Similarly, magnetocaloric driving devices can be assembled which incorporate smaller amounts of magnetocaloric material and smaller permanent magnets for applications requiring more modest levels of torque to be produced (Entries 2-3).

TABLE 1
Representative Torque Levels Developed Within a Magnetocaloric Valve

| | | | | M_{MCM} × m_{MCM} × |
|---|---|---|---|---|
| | | | | HYDROLYSIS |
| | | | | PRODUCT |
| Entry | M_{MCM} | m_{MCM} (kg) | H_{PM} | MIXTURE |
| 1 | 100 Joule Tesla⁻¹kg⁻¹ | 73 kg | 3 Tesla | 21900 Joule |
| 2 | 100 Joule Tesla⁻¹kg⁻¹ | 10 kg | 1 Tesla | 1000 Joule |
| 3 | 100 Joule Tesla⁻¹kg⁻¹ | 0.1 kg | 0.1 Tesla | 1 Joule |

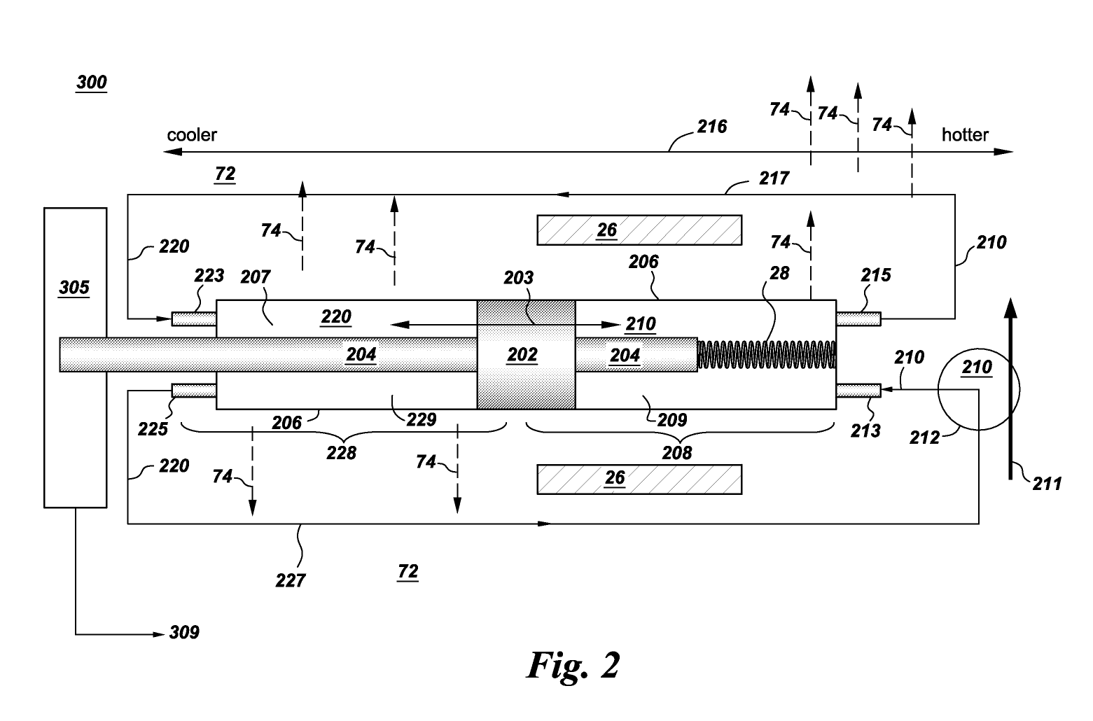

Returning now to the figures, FIG. 2 illustrates a magnetocaloric driving device 300 which produces mechanical energy output 309. In the embodiment shown, magnetocaloric piston 202 translates back and forth within a vessel 206 as discussed with reference to FIG. 1. During a piston stroke caused by an attractive interaction between magnetocaloric piston 202 and fixed magnet 26, hot fluid 210 is forced from first compartment 209 via fluid outlet 215 while simultaneously drawing cold fluid into second compartment 229. During a piston stroke caused by the release of a stored mechanical counter-force from counterpoise mechanism 28, shown in FIG. 2 as a compressible spring, hot fluid 210 is drawn into first compartment 209 via fluid inlet 213 while simultaneously forcing cold fluid 220 out of second compartment 229. As noted, fluid inlets 213 and 223, and fluid outlets 215 and 225, may be appropriately equipped with check valves in order to control the fluid input into and fluid output from the pump.

As piston strokes are repeated, fluid circulates from the first compartment to the second compartment and back again, and alternately loses heat 74 to a cold ambient environment 72 and gains heat in heat exchanger 212. Due to this fluid circulation, a temperature gradient 216 is set up across the device which enables the magnetocaloric piston to generate mechanical energy by being alternately cooled and heated by a heat sink, the cold fluid in second compartment 229, proximate to a heat source, the hot fluid in first compartment 209. A heat source fluid 211 may be used to heat cold fluid 220 returning through fluid conduit 227 in heat exchanger 212. In one or more embodiments, the heat source fluid is a production fluid from a hydrocarbon well.

The mechanical energy generated by the reciprocating motion 203 of the magnetocaloric piston 202 and piston shaft 204 may be transferred to energy transmission/conversion unit 305. In one embodiment, energy transmission/conversion unit 305 is a generator which converts piston shaft motion into electricity as the energy output 309 of the magnetocaloric driving device. Again, provided an appropriate heat source can be established proximate to a suitable heat sink, as is taught herein, the device is largely energetically independent.

In the discussion which follows, it is understood that the T_{C} of the magnetocaloric material present in the magnetocaloric component of the magnetocaloric driving device is substantially greater than the temperature of the cold ambient environment. In one or more embodiments, the magnetocaloric driving device provided by the present invention may be deployed in a cold subsea environment. Initially, the magnetocaloric driving device is at the same temperature as the cold ambient. As such, the magnetocaloric material will be magnetically susceptible and will engage as closely as it may to the magnet of the driving device. Additionally, the counterpoise mechanism will contain the maximum stored mechanical counter-force possible. No motion and counter motion will take place, however, until a suitable temperature gradient is established across the driving device. Thus, in one embodiment, hot and cold fluids are pumped by means of a priming pump into the nascent hot and cold zones respectively of the magnetocaloric driving device until a suitable mechanical rhythm and temperature gradient are established. The term mechanical rhythm refers to a time period associated with a moving component of the magnetocaloric driving device, for example the period of a piston stroke and counterstroke. In one or more embodiments, magnetocaloric driving devices provided by the present invention do not require a priming step.

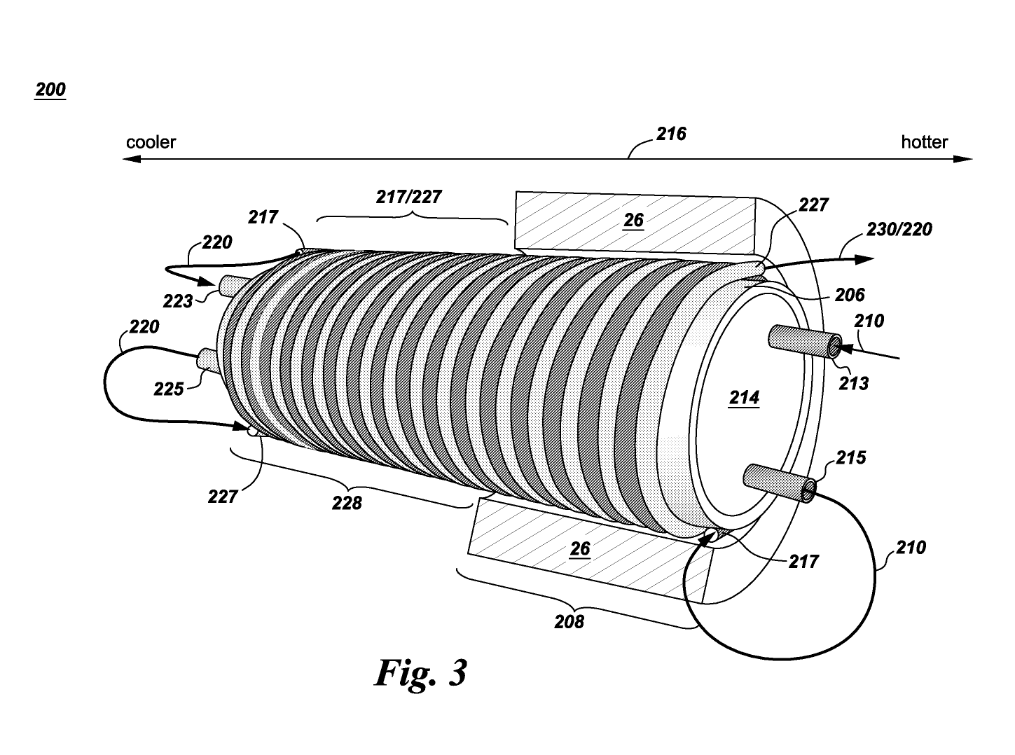

Referring to FIG. 3, the figure represents a portion of a magnetocaloric pump 200, the pump being configured to receive a hot fluid 210 and transmit a cold fluid 220 as the output 230 of the pump. In the embodiment shown, the only part of the magnetocaloric driving device which is visible is magnet 26, the remaining components; a magnetocalorically driven component (for example a magnetocaloric piston) and a counterpoise mechanism (for example a compressible spring) being disposed within cylindrical vessel 206 shown as closed at the ends by cylinder inserts 214. The fluid is pumped as hot fluid 210 drawn into a first compartment of the pump through fluid inlet 213 and cold fluid 220 which is simultaneously forced out of a second compartment of the pump through fluid outlet 225 during a first pump stroke. In a second pump stroke, opposite the first, hot fluid 210 is forced out of the of the first compartment via fluid outlet 215 while cold fluid is drawn into the second compartment via fluid inlet 223. A temperature gradient 216 is established as hot and cold fluids 210 and 220 circulate through fluid conduits 217 and 227 configured as a counter-flow heat exchanger. In the embodiment shown, the first and second compartments of the pump correspond roughly to hot zone 208 and cold zone 228 respectively. Provided a source of hot fluid 210 and cold fluid 220 are available, the pump illustrated in FIG. 3 may be largely energetically independent.

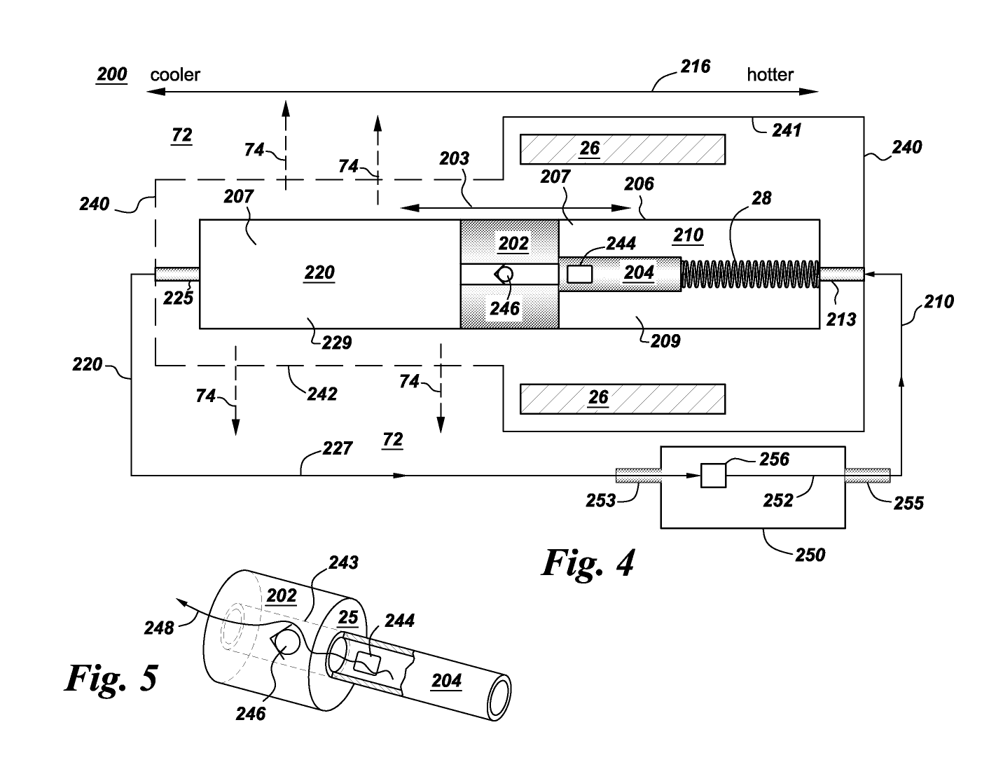

Referring to FIG. 4, the figure represents a magnetocaloric pump 200 and associated magnetocaloric driving device deployed adjacent to an equipment installation 250 requiring active cooling. In the embodiment shown, the motion 203 of magnetocaloric piston 202 alternately draws hot fluid into and forces hot fluid from first compartment 209, and alternately forces cold fluid from and draws cold fluid into second compartment 229. In a first piston stroke, hot fluid 210 is forced from first compartment 209 through flow channel 243 traversing magnetocaloric piston 202 into the second compartment 229. A check valve 246 disposed within flow channel 243 prevents cold fluid from being drawn into the first compartment during an opposite piston stroke. Flow channel 243 communicates with first compartment 209 via piston orifice 244. A fluid flow path 248 illustrates the fluid communication between first compartment 209 and second compartment 229 during a first piston stroke in which magnetocaloric piston 202 translates toward magnet 26. In an opposite piston stroke cold fluid is forced out of second compartment 229 as the magnetocaloric piston moves away from magnet 26 impelled by the stored mechanical counter-force of counterpoise mechanism 28, shown here as a compressible spring.

Still referring to FIG. 4, cold fluid 220 is forced from second compartment 229 and into cold fluid return conduit 227 and is presented to an equipment installation 250 requiring active cooling via equipment fluid inlet 253. As the cold fluid passes through coolant flow channel 252, heat is transferred from the equipment to cold fluid 220 which is transformed into hot fluid 210 within the coolant flow channel. Hot fluid 210 emerges at fluid outlet 255 and is returned to first compartment 209 via fluid inlet 213. As noted, fluid inlet 213 and fluid outlet 225 may be equipped with check valves to prevent uncontrolled fluid ingress and egress. For example, fluid inlet 213 may be equipped with a check valve which prevents hot fluid 210 from being forced back into equipment installation 250 during a first piston stroke. Similarly, fluid outlet 225 may be equipped with a check valve which prevents fluid from exiting second compartment 229 during the same first piston stroke. In a second piston stroke in which magnetocaloric piston 202 moves away from magnet 26, check valves in fluid inlet 213 and fluid outlet 225 permit the flow of cold fluid from second compartment 229 through fluid conduit 227 and equipment installation 250 into first compartment 209, while check valve 246 prevents cold fluid from entering first compartment via flow channel 243.

The pump is enclosed by housing 240 comprising a thermally insulated portion 241 and a heat transmissive portion 242. Heat loss, represented by arrows 74, across the heat transmissive portion of the housing creates the required temperature gradient 216.

In one or more embodiments, the magnetocaloric driving device may be primed by a primer pump. In the embodiment shown in FIG. 4, a priming pump 256 is located within equipment installation 250 and serves due role of providing coolant to installation 250 while simultaneously setting up the temperature gradient 216 within the magnetocaloric driving device. Once a suitable mechanical rhythm and temperature gradient are established in the magnetocaloric driving device it may be used to independently supply cold coolant fluid 220 to, and receive hot fluid 210 from installation 250.

Referring to FIG. 5, the figure represents the magnetocaloric piston 202 and its associated piston shaft 204 featured in FIG. 4 in somewhat greater detail so as to be more readily understood by those of ordinary skill in the art.

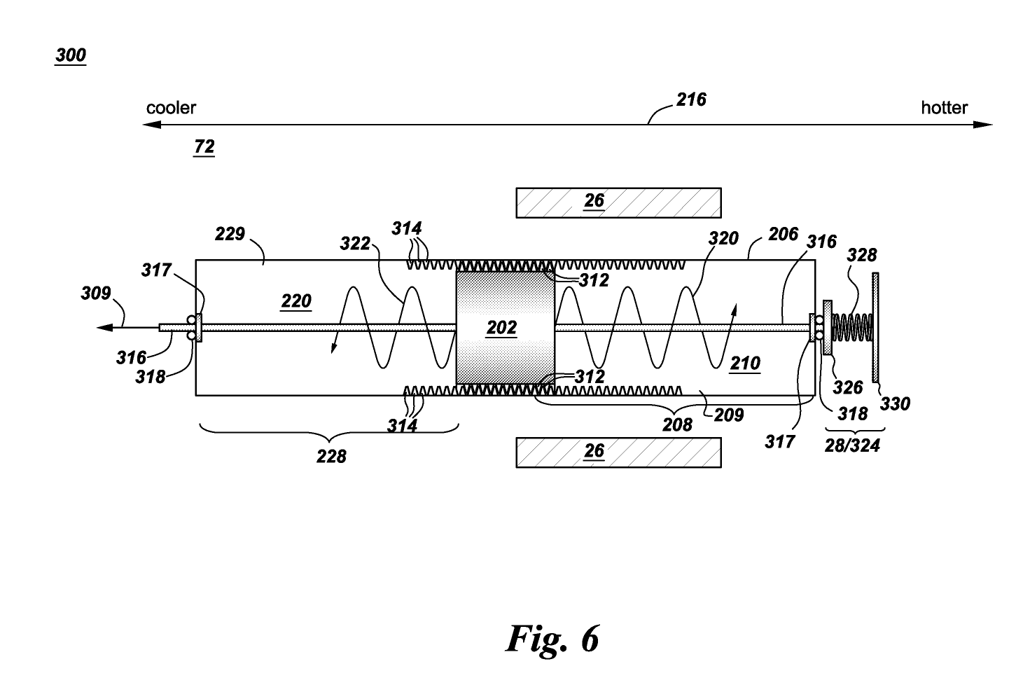

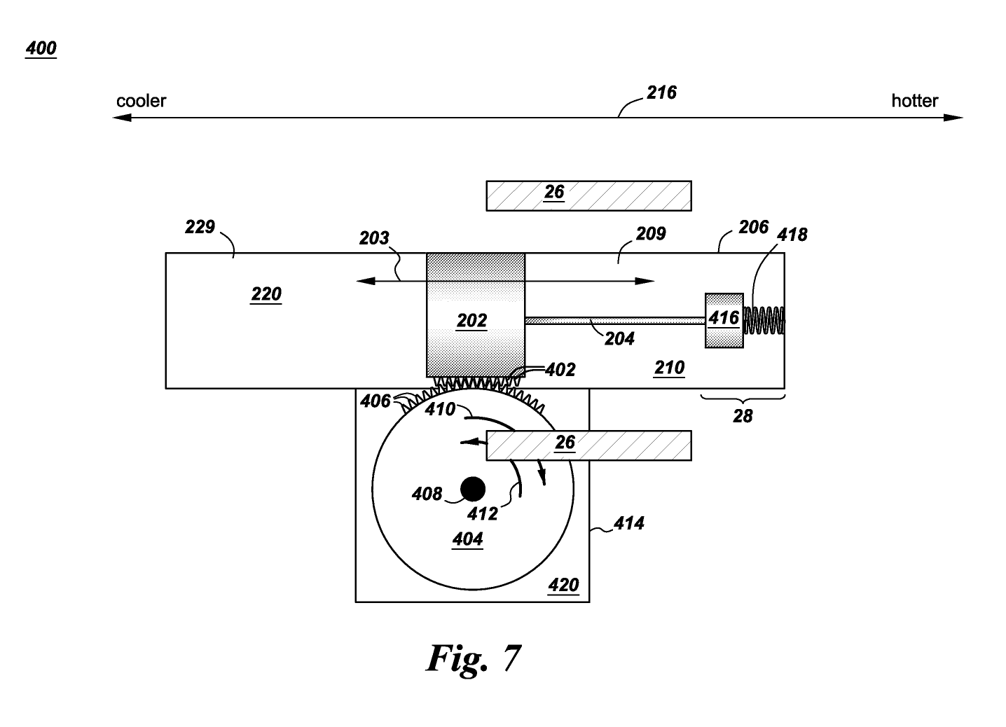

Referring to FIG. 6, the figure represents a magnetocaloric driving device 300 in which a magnetocaloric piston rotates within vessel 206 as it translates toward or away from magnet 26. In the embodiment shown, magnetocaloric piston 202 is equipped with continuous helical surface grooves 312, at times herein referred to as screw threads, which are complementary to a similar set of grooves 314 on the interior surface of vessel 206. In a first piston stroke, magnetocaloric piston 202 in a magnetically susceptible state rotates in direction 320 as it translates toward magnet 26. As magnetocaloric piston 202 rotates, spindle 316 co-rotates with it and stores torsional energy in counterpoise mechanism 28, also designated as torsion spring counterpoise mechanism 324. Spindle 316 passes through the end walls of vessel 206 and is supported at each end by spindle bearings 318. Spindle seals 317 allow for rotary movement of the spindle but prevent unwanted fluid egress from the vessel. The spindle connects to torsion spring 328 via rotary coupling 326 which co-rotates with the spindle and transfers the rotational energy of the spindle moving in direction 320 to the spring. Stationary base 330 prevents spring 328 from turning freely with rotary coupling 326 and enables the storage of a mechanical counter-force within counterpoise mechanism 28/324. In an opposite piston stroke, the magnetocaloric piston, no longer sufficiently attracted to magnet 26, is impelled by the stored mechanical counter-force in counterpoise mechanism 28/324 away from magnet 26 and into the cold zone 228. This time, the direction of rotation 322 of the spindle is opposite the direction of rotation of the spindle during the first piston stroke. The mechanical energy output 309 of the magnetocaloric driving device is shown as exiting the device at an end of the device opposite the counterpoise mechanism, but those of ordinary skill in the art and having read this disclosure will understand that may other advantageous configurations are possible, including a configuration of the device in which the positions of counterpoise mechanism 28/324 and the mechanical energy output have been switched.

Still referring to FIG. 6, those of ordinary skill in the art will understand that as magnetocaloric piston translates within cylindrical vessel 206 the relative sizes of first compartment 209 and second compartment 229 will change and provision must be made for fluid compression and expansion as the piston moves. In one or more embodiments, the grooves 312 of magnetocaloric piston 202 and the complementary grooves on the interior surface of the vessel are appropriately sized and shaped such that fluid may be transferred via the grooves between the first compartment and the second compartment. Under such circumstances, fluid flows in one direction between the compartments during a first piston stroke and fluid flows in an opposite direction between the compartments during an opposite piston stroke and, as such, the magnetocaloric driving device may be a closed system with respect to fluids 210 and 220. Under such circumstances, the temperature gradient required may be provided independently, for example by wrapping the magnetocaloric driving device with alternating coils conducting hot and cold water, for example, the coils configured as a counter-flow heat exchanger as in FIG. 3 along the long axis of the vessel 206.

In an alternate set of embodiments, grooves 312 and 314 effectively inhibit fluid transfer between first compartment 209 and second compartment 229. Under such circumstances, fluid inlets 213/223 and fluid outlets 215/225 may be incorporated as variously taught herein to allow for the displacement of fluid from, or the addition of fluid into, the first and second compartments.

Referring to FIG. 7, the figure represents a magnetocaloric driving device 400 wherein the reciprocating motion 203 of a magnetocaloric piston is converted into rotary motion by coupling the magnetocaloric piston to a toothed wheel 404. Thus, a surface of the magnetocaloric piston is equipped with teeth 402 mated to complementary structures 406 on the outer rim of toothed wheel 404. As magnetocaloric piston in a magnetically susceptible state is attracted to and moves toward magnet 26, toothed wheel 404 rotates in direction 410 as a mechanical counter-force is stored in counterpoise mechanism 28, shown here as a compressible spring 418. Piston shaft 204 couples to compressible the spring via coupling 416. As the magnetocaloric material within magnetocaloric piston warms and becomes less magnetically susceptible, magnetocaloric piston 202 is impelled away from magnet 26 by the mechanical counter-force stored in the counterpoise mechanism, as toothed wheel 404 rotates in direction 412. In one or more embodiments, the toothed wheel may be mechanically coupled to a rotary shaft 408.

In one or more embodiments, interlocking teeth 402 and 406 are appropriately sized and shaped such that fluid may be transferred between the first compartment and the second compartment via interstices between the interlocking teeth. Under such circumstances, fluid flows in one direction between the compartments during a first piston stroke and fluid flows in an opposite direction between the compartments during an opposite piston stroke, and the magnetocaloric driving device may be a closed system with respect to fluids 210 and 220. Under such circumstances, the temperature gradient required by the magnetocaloric driving device may be provided independently as variously taught herein.

In one or more embodiments, interlocking teeth 402 and 406 effectively inhibit fluid transfer between first compartment 209 and second compartment 229. Under such circumstances, fluid inlets 213/223 and fluid outlets 215/225 may be incorporated as variously taught herein to allow for the displacement of fluid from, or the addition of fluid into, the first and second compartments.

In one or more embodiments, toothed wheel 404 is disposed within an enclosure 414, the internal volume 420 of which may contain a hot fluid, a cold fluid or a fluid characterized by a temperature gradient across the enclosure. Enclosure 414 may be equipped with fluid inlets 213/223 and fluid outlets 215/225 as variously taught herein to allow for the displacement of fluid from, or the addition of fluid into, the first and second compartments, and the enclosure itself In one embodiment, enclosure 414 is fluid filled, the fluid being characterized by a temperature gradient 216. Under such circumstances, it may be advantageous to minimize the size of gaps between the interior surfaces of the enclosure and one or more surfaces of the toothed wheel. Rotary shaft 408 may exit the enclosure via one or more seals which permit rotation of the shaft while preventing fluid egress from the enclosure.

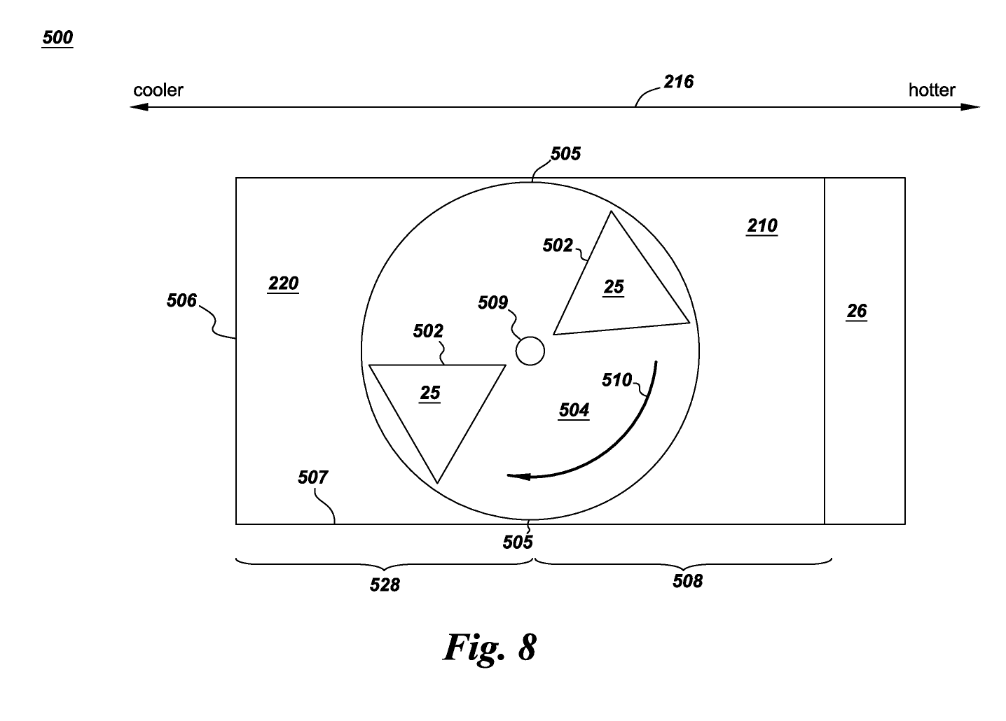

Referring to FIG. 8, the figure represents a magnetocaloric driving device 500 comprising magnetocaloric elements 502 disposed within a cylinder 504 configured to rotate about axis 509 in response to an attractive interaction between magnetocaloric material 25 in a magnetically susceptible state and fixed magnet 26. In the embodiment shown, the cylinder is enclosed within enclosure 506 containing a fluid defining a temperature gradient between a hot zone 508 and a cold zone 528. In one embodiment, the fluid defining a temperature gradient is a gas such as air, SF₆ (boiling point=−64° C.) or argon. In another embodiment, the fluid is a liquid at ambient temperature, for example perfluoroctane. In one embodiment, the cylinder is configured to rotate in direction 510. It may be advantageous to minimize the size of gaps 505 between the interior surfaces 507 of the enclosure and one or more surfaces of the cylinder, for example as shown. A rotary shaft 408 may exit the enclosure via one or more seals which permit rotation of the shaft or spindle while preventing fluid egress from the enclosure.

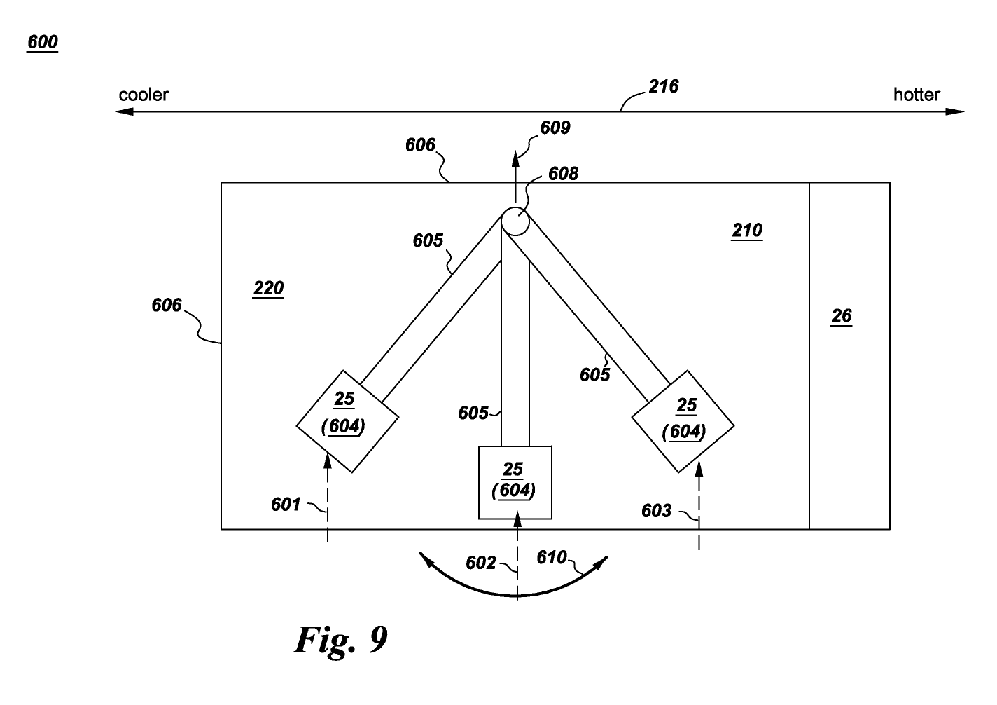

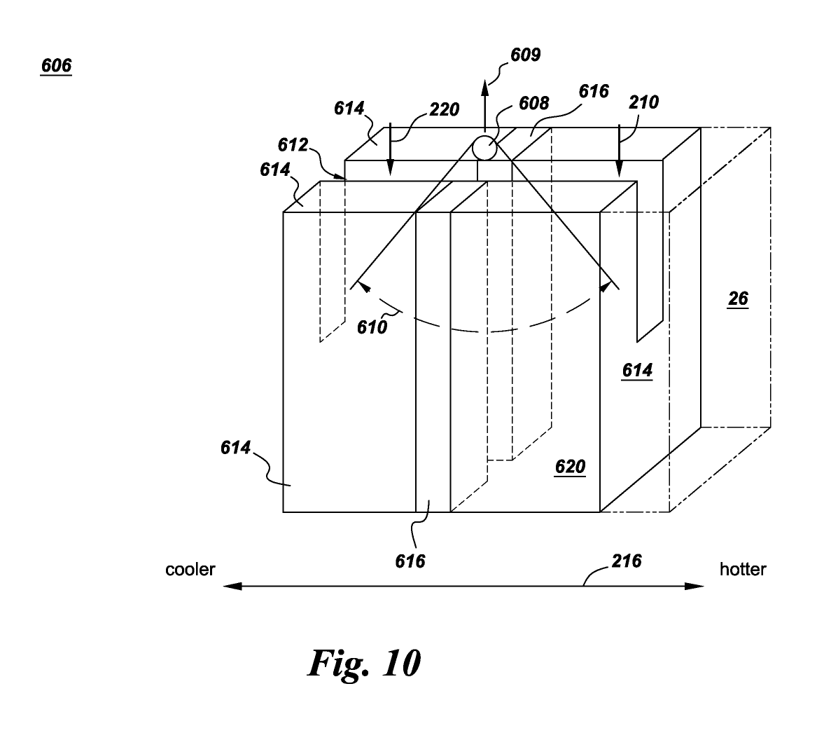

Referring to FIG. 9, the figure represents a magnetocaloric driving device 600 comprising a magnetocaloric pendulum. The pendulum comprises pendulum weight 604 comprising one or more magnetocaloric materials 25, the pendulum weight being attached to pendulum shaft 605, shaft 605 being attached to pendulum pivot point 608. In the embodiment shown, the pendulum weight is shown in three positions 601, 602 and 603 along arc of motion 610. The magnetocaloric pendulum is disposed within an enclosure 606 permitting the formation of a temperature gradient 216. The pendulum weight cools as it moves along arc of motion 610 on the cold side of the enclosure and becomes magnetically susceptible during passage through the cold fluid 220 and is attracted to fixed magnet 26. In one or more embodiments, the degree to which the magnetocaloric material 25 present in the pendulum weight is magnetically susceptible is at a maximum during the downward motion of pendulum weight on the cold side of the enclosure (i.e. between pendulum positions 601 and 602). As such, the pendulum weight gets an energetic boost as it travels toward and is attracted to fixed magnet 26. Useful mechanical energy 609 may be tapped from pivot point 608. Those of ordinary skill in the art will understand that in the embodiment shown in FIG. 9, gravity qualifies as the counterpoise mechanism 28. Owing to its magnetocaloric nature, provided the required temperature gradient is established and maintained, the pendulum will be largely energy self-sufficient.

In one or more embodiments it may be useful to employ a start-up protocol to initiate the motion of a magnetocaloric component, or its magnetic complement, of the magnetocaloric driving device. As noted, in one or more embodiments, this start up protocol may comprise a fluid priming step. Alternatively, it may be useful to initiate the motion of the magnetocaloric component of the driving device with the magnetocaloric material 25 already in a magnetically susceptible state. For example, prior to setting pendulum weight 604 (FIG. 9) in motion, it may be useful to establish a temperature gradient within enclosure 606 with pendulum weight temporarily fixed at position 601 until magnetocaloric material is sufficiently cool to be attracted by and move with the requisite force toward magnet 26. Similarly, prior to setting magnetocaloric cylinder 500 (FIG. 8) in motion, it may be useful to establish a temperature gradient within enclosure 506 with magnetocaloric driving elements 502 temporarily fixed at non-equilibrium positions (See FIG. 8) until the magnetocaloric material of one of elements 502 is sufficiently cool to be attracted by and move with the requisite force toward magnet 26 and rotate the cylinder thereby.

Referring to FIG. 10, the figure represents an enclosure 606 which may be used to create a temperature gradient needed to drive a magnetocaloric pendulum such as that disclosed in FIG. 9. The enclosure is essentially a box bounded by walls 614 defining an interior volume 620. A gap 612 in the top and sides of the box is sized to accommodate the swinging pendulum along arc of motion 610. Baffles 616 divide the interior volume of the box to the greatest extent possible while allowing sufficient space between them for the pendulum to swing through. A hot fluid 210, for example hot air, is continuously introduced into the interior of the box via the gap on the right side of the enclosure. A cold fluid 220, for example cold air, is continuously introduced into the interior of the box via the gap on the left side of the enclosure to achieve the needed temperature gradient 216. Various sources of hot and cold gaseous fluids may be employed. For example, hot fluid 210 may be a gas stream from a combustion engine and cold fluid 220 may be cold ambient air taken from the environment. In one or more embodiments, a portion of the mechanical energy output 609 of the magnetocaloric pendulum may be used to supply fluids 210 and/or 220 to the enclosure.

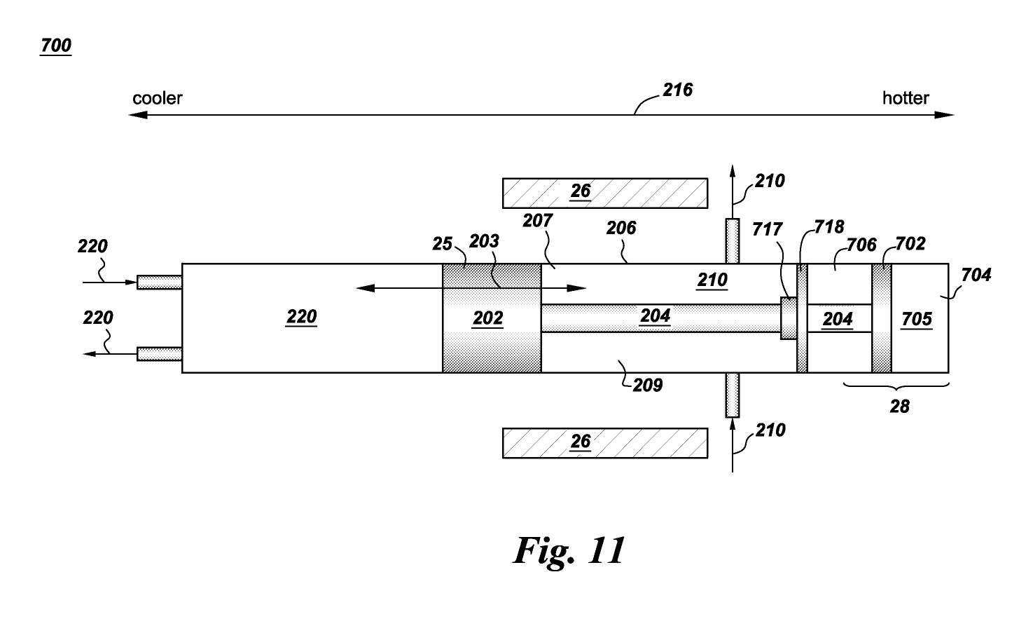

Referring to FIG. 11, the figure represents a magnetocaloric driving device 700 comprising a gas compression chamber 704 and a compressible gas 705 as key elements of the counterpoise mechanism 28. In the embodiment shown, the magnetocaloric driving device is configured to drive a fluid pump. Thus, as magnetocaloric piston 202 moves toward magnet 26 it causes piston shaft 204 to move through shaft seal 717 and insulated wall 718 and apply a force to compression piston 702. As compression piston 702 moves in response to the force exerted by piston shaft 204 the gas 705 is compressed and stores a counter-force in counterpoise mechanism 28. As the magnetocaloric piston 202 warms and ceases to be sufficiently magnetically susceptible to resist the stored counter-force of the counterpoise mechanism, the magnetocaloric piston moves away from magnet 26 as compression chamber 704 expands. Interior volume 706 of the vessel 206 grows and shrinks according to the movement of compression piston 702. In one or more embodiments, interior volume 706 is vented to maintain a constant pressure as compression piston moves.

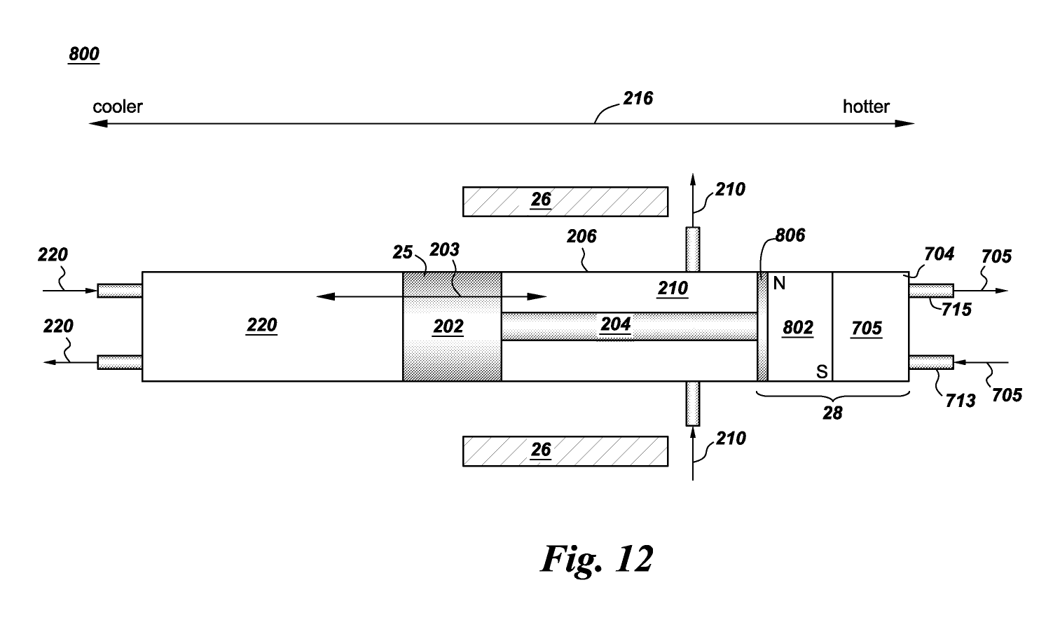

Referring to FIG. 12, the figure represents a magnetocaloric driving device 800 wherein the counterpoise mechanism comprises a magnet 802 which is magnetically susceptible with respect to magnet 26 and mechanically coupled to piston shaft 204. The counterpoise mechanism further comprises compression chamber 704 comprising one or more compressible gases 705. Magnet 802 comprises a thermal barrier 806 which inhibits heat transfer from hot fluid 210 to the gas within the compression chamber. As magnetocaloric piston 202 translates toward magnet 26, magnet 802 acting as a compression piston moves in response to the movement of piston shaft 204, compresses gas 705 and creates a restorative mechanical counter-force in compression chamber 704 which together with the attraction between magnet 802 and magnet 26 provide the energy required for a piston counterstroke in which magnetocaloric piston 202 moves away from magnet 26. Magnetocaloric piston 202 and magnets 26 and 802 are sized appropriately such that, when in one or more magnetically susceptible states, the force with which the magnetocaloric piston is drawn to magnet 26 is greater than the force with which magnet 802 is drawn to magnet 26. In one or more embodiments, magnetocaloric driving device 800 may configured as a gas compressor, with gas 705 entering and exiting compression chamber 704 through fluid inlet 713 and fluid outlet 715.

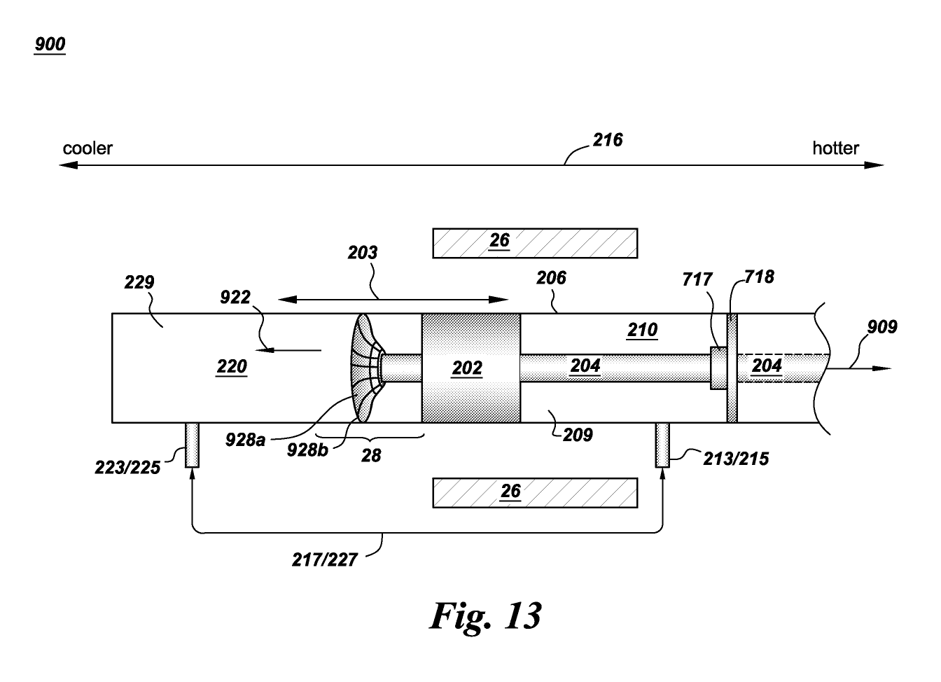

Referring to FIG. 13, the figure represents a magnetocaloric driving device 900 wherein the counterpoise mechanism 28 comprises a reinforced elastic diaphragm comprising diaphragm 928a and reinforcing rings 928b, the largest of which is fixedly attached to the interior surface of cylindrical vessel 206. As magnetocaloric piston 202 in a magnetically susceptible state is drawn toward magnet 26, counterpoise mechanism 28 which is coupled to piston shaft 204 is stretched in the direction of magnet 26 thereby creating a stored counter-force in stretched diaphragm 928a and represented as arrow 922 indicating the direction of net force exerted by the counterpoise mechanism on magnetocaloric piston. Vessel 206 may be equipped with fluid inlets 213/223 and fluid outlets 215/225 as variously taught herein to allow for the displacement of fluid from, or the addition of fluid into, the first and second compartments 209 and 229. Mechanical energy 909 may be extracted from the driving device via the reciprocating motion of piston shaft 204. In one or more embodiments, diaphragm 928a is a porous membrane through which fluids 210 and 220 may pass.

In one or more embodiments, the magnetocaloric driving devices provided by the present invention are marinized and configured for operation at great ocean depths. For example, various cavities within the magnetocaloric driving device may be fluid filled in order to enhance resistance to the enormous pressure exerted on the device by the water column.

As noted, in one embodiment, the present invention provides a method of producing a fluid using a magnetocaloric pump of the invention. The method may rely energetically on a combination of a hot or cold production fluid with an accessible ambient heat sink or heat source. The method may be practiced in a wide variety of human endeavors such as the production of oil from a deep ocean subsea reservoir. The method is also suitable for use in the chemical industry where hot and cold production fluids in proximity to ambient heat sinks and heat sources are common

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. A magnetocaloric driving device comprising:
a magnet, an effective amount of a magnetocaloric material, and a counterpoise mechanism;
wherein the driving device is configured to generate mechanical energy by alternately cooling and heating the magnetocaloric material using a heat sink proximate to a heat source.

2. The magnetocaloric driving device according to claim 1, wherein the magnetocaloric material is configured to move relative to the magnet, the magnet being stationary.

3. The magnetocaloric driving device according to claim 1, wherein the magnet is configured to move relative to the magnetocaloric material, the magnetocaloric material being stationary.

4. The magnetocaloric driving device according to claim 1, wherein both the magnetocaloric material and the magnet are configured to move.

5. The magnetocaloric driving device according to claim 1, wherein at least a portion of the magnetocaloric material is comprised within a magnetocaloric piston.

6. The magnetocaloric driving device according to claim 1, wherein at least a portion of the magnetocaloric material is comprised within a cylinder configured to rotate.

7. The magnetocaloric driving device according to claim 1, wherein at least a portion of the magnetocaloric material is comprised within a pendulum weight.

8. The magnetocaloric driving device according to claim 1, wherein the counterpoise mechanism comprises a compressible spring.

9. The magnetocaloric driving device according to claim 1, wherein the counterpoise mechanism comprises a torsion spring.

10. The magnetocaloric driving device according to claim 1, wherein the counterpoise mechanism is a pendulum.

11. The magnetocaloric driving device according to claim 1, wherein the counterpoise mechanism comprises a compressible gas.

12. The magnetocaloric driving device according to claim 1, wherein the counterpoise mechanism comprises at least one magnet.

13. The magnetocaloric driving device according to claim 1, wherein the counterpoise mechanism comprises an elastic material.

14. The magnetocaloric driving device according to claim 1, wherein the magnetocaloric material is configured for alternate cooling and heating by sequential thermal contact with a production fluid heat source and an ambient heat sink.

15. The magnetocaloric driving device according to claim 1, wherein the magnetocaloric material is configured for alternate cooling and heating by sequential thermal contact with a production fluid heat sink and an ambient heat source.

16. A magnetocaloric driving device comprising:
a magnet, an effective amount of a magnetocaloric material, and a counterpoise mechanism;
wherein the driving device is configured to generate mechanical energy by alternately cooling the magnetocaloric material by thermal contact with an ambient heat sink and heating the magnetocaloric material by thermal contact with a production fluid.

17. The magnetocaloric driving device according to claim 16, further comprising a signal actuated latch configured to regulate a change in the relative positions of the magnet and the magnetocaloric material.

18. A magnetocaloric pump comprising:
a magnetocaloric driving device comprising a magnet, an effective amount of a magnetocaloric material, and a counterpoise mechanism; and
a vessel defining a first compartment and a second compartment, separated by a blocking member configured to translate in a first direction under the influence of an attractive force between the magnetocaloric material and the magnet, and to translate in a second direction under the influence of a stored mechanical counter-force;
wherein the first compartment is configured to receive and transmit a first fluid having an average temperature T₁, the second compartment is configured to receive and transmit a second fluid having a average temperature T₂, the blocking member being configured to limit fluid communication between the first and second compartments, the pump being configured such that T₁ is substantially greater than T₂.

19. The magnetocaloric pump according to claim 18, wherein the blocking member is a magnetocaloric piston.

20. The magnetocaloric pump according to claim 18, wherein the blocking member is a counterpoise mechanism.
